(19) United States
(12) Patent Application Publication
(10) Pub. No.: US 2010/0250984 A1
(43) Pub. Date: Sep. 30, 2010

(54) ELECTRONIC DEVICE AND POWER SAVING METHOD THEREOF

(75) Inventors: Jian-Wei Lee, Taipei County (TW); Hsin-Yu Chen, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ACER INCORPORATED, Taipei County (TW)

(21) Appl. No.: 12/646,046

(22) Filed: Dec. 23, 2009

(30) Foreign Application Priority Data
Mar. 26, 2009 (TW) 098110016

(51) Int. Cl. G06F 1/32; G06F 3/048

(52) U.S. Cl. 713/320; 715/781

(57) ABSTRACT

The present invention discloses an electronic device and power saving method thereof. In an embodiment, when the electronic device operates in a power-saving mode, which means an area on a screen of the electronic device is not a currently in-focus window-based interface, the area is adjusted to have reduced backlight brightness. Thus, not only the power consumed by the screen is reduced but also user experience can be maintained. In another embodiment, when the electronic device operates in a power-saving mode, display parameters for an image shown in the currently in-focus window-based interface are changed without adversely affecting the power-saving effect, so that the currently in-focus window-based interface has higher display definition than other areas do.

### FIELD OF THE INVENTION

The present invention relates to an electronic device and power saving method thereof; and more particularly, to an electronic device and power saving method thereof that allows the electronic device in a power-saving mode to have different levels of display definition in different areas on a display screen of the electronic device.

### BACKGROUND OF THE INVENTION

Currently, people pay more attention to the energy saving technologies and power saving methods for electronic devices. For example, a notebook computer will enter into a power-saving mode when it is powered by a battery thereof. Also, to reduce the power consumed by a notebook computer and to further extend the working time of the notebook computer, different measures have been taken, such as reduced working clock rate of the central processing unit, disabled wireless communication module, reduced screen backlight brightness, etc. However, it is very important to maintain the user in comfortable operating environment while taking the above measures to save the power consumption and extend the working time of the notebook computer. For example, when the screen has reduced backlight brightness, the definition of the screen would inevitably be adversely affected at the same time. Thus, it is desirable to develop a way that can reduce the power consumption of a notebook computer without sacrificing the user's feeling during operating the notebook computer or other portable device.

### SUMMARY OF THE INVENTION

One of the objects of the present invention is to provide an electronic device and power saving method thereof. That can reduce the power consumption in a power-saving mode with maintenance of a comfortable operating environment.

To achieve the object of the present invention, an electronic device with power saving mode is provided. The electronic device according to a preferred embodiment of the present invention includes a data processing unit and a display unit. The data processing unit processes a data, and the display unit displays the data having been processed by the data processing unit. The display unit has a first operating area and a second operating area shown on a screen thereof. When detecting the occurrence of a preset event, the data processing unit adjusts the display unit to display in a power-saving mode, such that the first operating area is arranged to have higher display definition than that of the second operating area does.

Preferably, the preset event in the electronic device can include any of the following conditions: a power-saving mode is actuated, an external power supply is removed, the electronic device is powered by a battery, the battery level of the electronic device is lower than a preset value, and an execution command signal is received by data processing unit.

In an operable embodiment of the present invention, the display unit preferably includes a plurality of light-emitting units. When the display unit displays in the power-saving mode, some of the light-emitting units corresponding to the first operating area have higher brightness than other light-emitting units corresponding to the second operating area do.

In another embodiment of the present invention, the data processing unit executes a Windows Operating System, and the first operating area or the second operating area is a window-based interface generated when executing the Windows Operating System. Also, the first operating area is preferably a currently in-focus window-based interface.

In another operable embodiment of the present invention, the data processing unit adjusts display parameters for an image shown in the first operating area or the second operating area, so that the first operating area has higher display definition than the second operating area does.

To achieve the second object, a power saving method is provided. The power saving method according to the present invention includes the following steps of detecting whether a preset event has occurred or not; and adjusting the display unit into a power-saving mode if the preset event is detected, so that the first operating area has higher display definition than the second operating area does.

In the present invention, preferably, the preset event in the power saving method can include any of the following conditions: a power-saving mode is actuated, an external power supply is removed, the electronic device is powered by a battery, the battery level of the electronic device is lower than a preset value, and an execution command signal is received by the data processing unit.

When the display unit includes a plurality of light-emitting units, the power saving method of the present invention further includes the following step of adjusting the plurality of light-emitting units, such that some of the light-emitting units corresponding to the first operating area has higher brightness than other light-emitting units corresponding to the second operating area does.

In the power saving method of the present invention, the first operating area or the second operating area is a window-based interface generated when the electronic device executes a Windows Operating System. Also, the first operating area is preferably a currently in-focus window-based interface.

In the present invention, the power saving method further includes the step of adjusting display parameters for an image shown in the first operating area or the second operating area, so that the first operating area has higher display definition than the second operating area does.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an electronic device according to a first embodiment of the present invention;

FIG. 2 shows a power-saving embodiment for the electronic device of the present invention;

FIG. 3 shows a power-saving embodiment for the electronic device of the present invention;

FIG. 4 shows a power-saving embodiment for the electronic device of the present invention;

FIG. 5 shows a power-saving embodiment for the electronic device of the present invention;

FIG. 6 is a block diagram of an electronic device according to a second embodiment of the present invention;

FIG. 7 is a flowchart showing the steps included in a power saving method according to the present invention; and

FIG. 8 is a flowchart showing the steps included in an embodiment of the power saving method of the present invention.

### DETAILED DESCRIPTION OF THE PREFERRED EMBODIMENTS

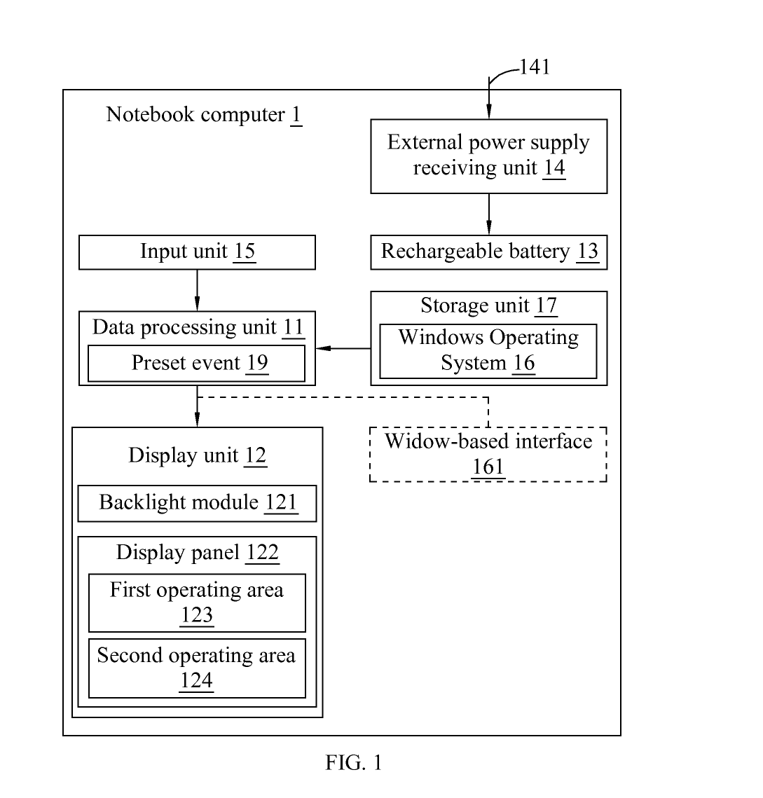

Please refer to FIG. 1, which is a block diagram of an electronic device according to a first embodiment of the present invention. To illustrate first embodiment, the electronic device is a notebook computer 1. As shown, the notebook computer 1 includes a data processing unit 11, a display unit 12, a rechargeable battery 13, an external power supply receiving unit 14, an input unit 15, and a storage unit 17. The data processing unit 11 is adapted to execute a Windows Operating System 16, so as to provide related functions for managing the hardware and drivers of the notebook computer 1 and to provide at least one window-based interface 161. The window-based interface 161 is shown in the display unit 12 for user to operate. Through the input unit 15, the user operates on the window-based interface 161 to use and manage the notebook computer 1. The input unit 15 is preferably a keyboard, a mouse, or a touch module. The storage unit 17 stores a plurality of programs executed by the data processing unit 11, such as aforementioned Windows Operating System 16. The data processing unit 11 is preferably a central processing unit (CPU) or a microcontroller. The storage unit 17 is preferably a memory, a hard disk drive, or an optical storage device. The display unit 12 includes a backlight module 121 and a display panel 122. The display panel 122 displays data processed by the data processing unit 11, and the backlight module 121 emits light passing through the display panel 122 to allow users to clearly watch a screen of the display panel 122.

The rechargeable battery 13 and the external power supply receiving unit 14 provide the power for the operation of the notebook computer 1. The external power supply receiving unit 14 can be connected to a power cord 141 for receiving an external power supply, which can be used to charge the rechargeable battery 13 as well as provided the notebook computer 1 with power to operate thereon. To extend the working time of the notebook computer 1 and to reduce the power consumption thereof, the data processing unit 11, when detecting the occurrence of a preset event 19, automatically adjusts the display unit 12 to display in a power-saving mode to reduce the power consumption thereof. The preset event 19 can include at least one of the following conditions:

(i) A power-saving mode is actuated on the electronic device. For example, when the user manually operates the Windows Operating System 16 to actuate a power-saving mode for the purpose of reducing the power consumed by the notebook computer 1, the data processing unit 11 is brought to adjust the display unit 12 to display in a power-saving mode;

(ii) An external power supply of the electronic device is removed. For example, the user unplugs the power cord 141 from the notebook computer 1 in order to move the notebook computer 1 freely. At this point, the notebook computer 1 must be powered by the rechargeable battery 13. To extend working time of the battery-powered notebook computer 1, the data processing unit 11 will adjust the display unit 12 to display in a power-saving mode; and

(iii) The battery level of the electronic device is lower than a preset value. For example, in the notebook computer 1, when the data processing unit 11 detects that the rechargeable battery 13 has a power level lower than 50% or 30%, the data processing unit 11 will adjust the display unit 12 to display in a power-saving mode, so as to extend user's working time of the notebook computer 1 before the rechargeable battery 13 is exhausted.

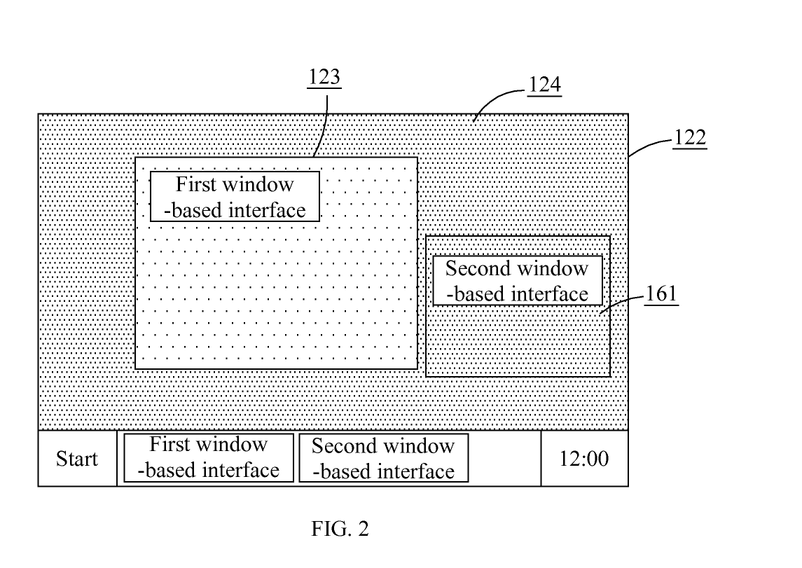

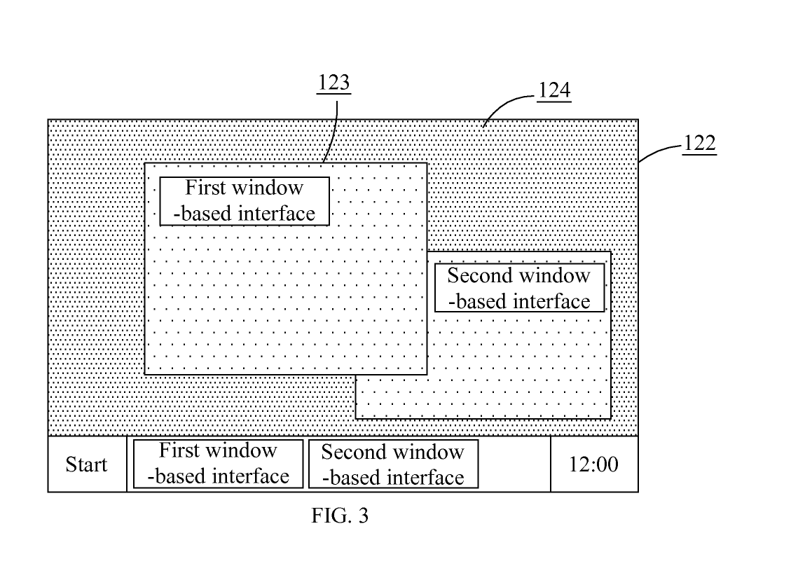

To effectively reduce the power consumption of the display unit 12 through the power-saving display mode, the data processing unit 11 reduces the power-supply voltage to the backlight module 121, so that the backlight module 121 will have a lowered luminous intensity. Please also refer to FIGS. 2 and 3, in which the loosely dotted areas represent areas on the display panel 122 that have a reduced luminous intensity. To maintain the user's comfortable operation, the data processing unit 11 will adjust the display parameters for the image shown in a first operating area 123 or a second operating area 124, so that the first operating area 123 has display definition higher than that of the second operating area 124.

In FIG. 2, the first operating area 123 is defined as an in-focus first window-based interface that is a currently used window, and the second operating area 124 is defined as an area other than the first operating area 123. Thus, a second window-based interface is the second operating area 124. When the user changes to use a second window-based interface later, the first operating area 123 is reassigned to the second window-based interface and the second operating area 124 is reassigned to the area other than the first operating area 123. Thus, the first window-based interface is the second operating area 124 now.

Further, the first operating area 123 can be otherwise defined as all the currently opened window-based interfaces on the display panel 122. For example, in FIG. 3, the first operating area 123 is an area covered by the first window-based interface and the second window-based interface, and the second operating area 124 is an area other than the first operating area 123.

In FIG. 2 and FIG. 3, the data processing unit 11 can adjust the display parameters. For example, the display parameters include the contrast, the brightness, the saturation, and/or the sharpness of the image shown in the first operating area 123 and the second operation 124. Therefore, techniques about increasing the display definition of the first operating area 123, which is currently viewed, operated, or concerned by the user, or techniques about decreasing the display definition of the second operation area without adversely affecting the power saving of the display unit 12 may be obtained. Since the techniques for increasing or decreasing the contrast, the brightness, the saturation, and/or the sharpness of image data through image processing are known by one skilled in the art, they are not discussed in details herein.

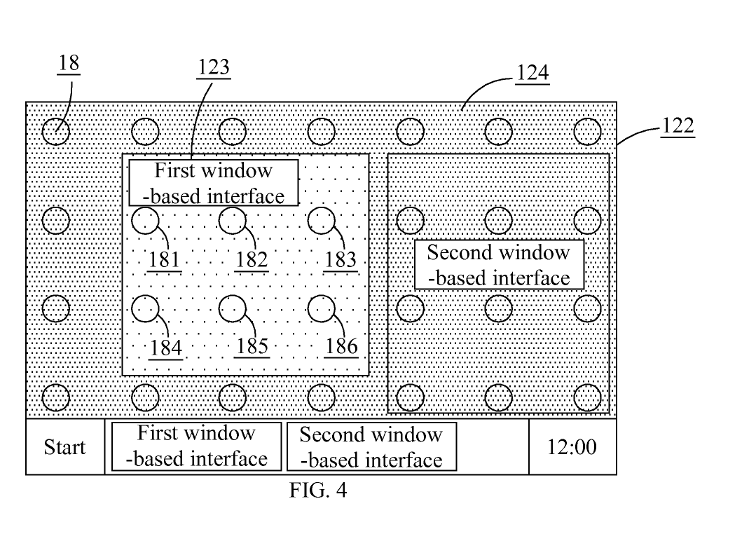

In the case that the display unit 12 includes a plurality of light-emitting units 18, such as light-emitting diodes or cold cathode fluorescent lamps (CCFLs), it is also possible to adjust the first operating area 123 to a display definition higher than that of the second operating area 124 through controlling the plurality of light-emitting units 18. As shown in FIG. 4, the backlight module 121 of the display unit 12 includes total 28 light-emitting units 18 arrayed in four rows and seven columns, and each of the 28 light-emitting units 18 can be independently adjusted to different levels of brightness. Therefore, when the display unit 12 displays in the power-saving mode, information related to the currently in-focus window-based interface, such as the size, the initial window position, the layer of the window, etc., can be obtained from the Windows Operating System 16 in FIG. 1 to indicate the first operating area 123, such as the first window-based interface shown in FIG. 4. Besides, the second operating area 124 is the area other than the first operating area 123.

Then, the light-emitting units 181˜186 corresponding to the first operating area 123 are adjusted to have reduced brightness 70% compared to the original brightness. Meanwhile, all other light-emitting units 18 corresponding to the second operating area 124 are adjusted to have reduced brightness 50% compared to the original brightness. For example, if there are twenty-eight light-emitting units 18 arranged in the backlight module 121 and there are six light-emitting units 18 in the first window-based interface (181, 182, 183, 184, 185, and 186 in FIG. 4), the overall brightness of the backlight module 121 can be obtained by the following formula: 6/28*70%+(28−6)/28*50%. As a result, an overall brightness of the backlight module 121 is reduced to be 54.3% of the original brightness. In this manner, the power consumed by the backlight module 121 can be reduced while the area on the screen concerned by the user can still have a suitable brightness to maintain the user's comfortable operation. Notice that aforementioned brightness 70% and 50% are only intended for illustration without limiting the present invention. Any means that can adjust the light-emitting units corresponding to the first operating area 123 to have brightness higher than that of other light-emitting units corresponding to the second operating area 124 shall be included in the scope of the present invention. Moreover, depending on actual need, the data processing unit 11 can adjust the display parameters, such as the contrast, the brightness, the saturation, and/or the sharpness, for the second operating area 124 that has a relatively darker backlight, so as to compensate the low definition of the second operating area 124 resulted from the darkened backlight thereof.

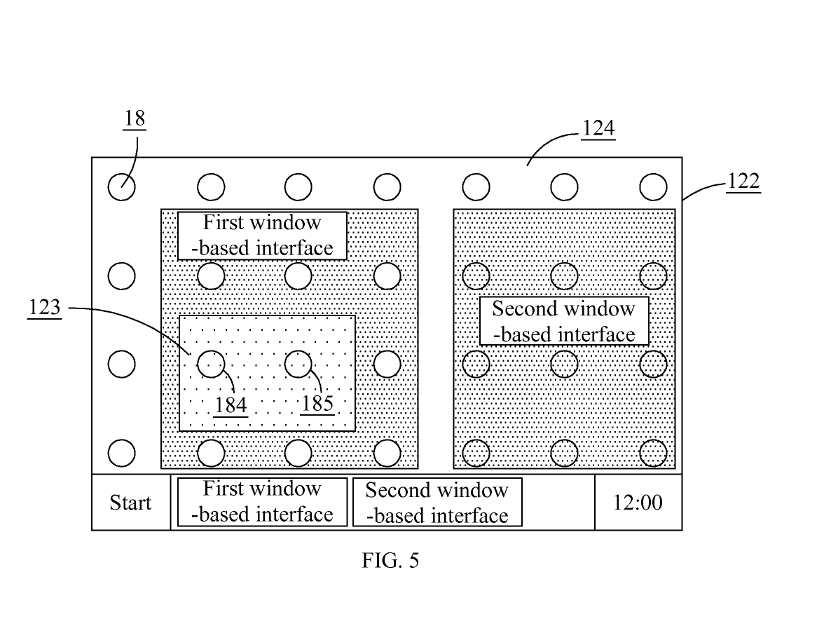

Alternatively, referring to FIG. 5, the first operating area 123 can be defined as a video playback area, such as the active area defined by the multimedia playing application program, or a web browser window which a user watches a video stream on. Information related to the video playback area can be obtained from the Windows Operating System 16 in FIG. 1 or the data processing unit 11 in FIG. 1 performing image processing on images shown on the display panel 122 in order to compute the location and size of the video playback area.

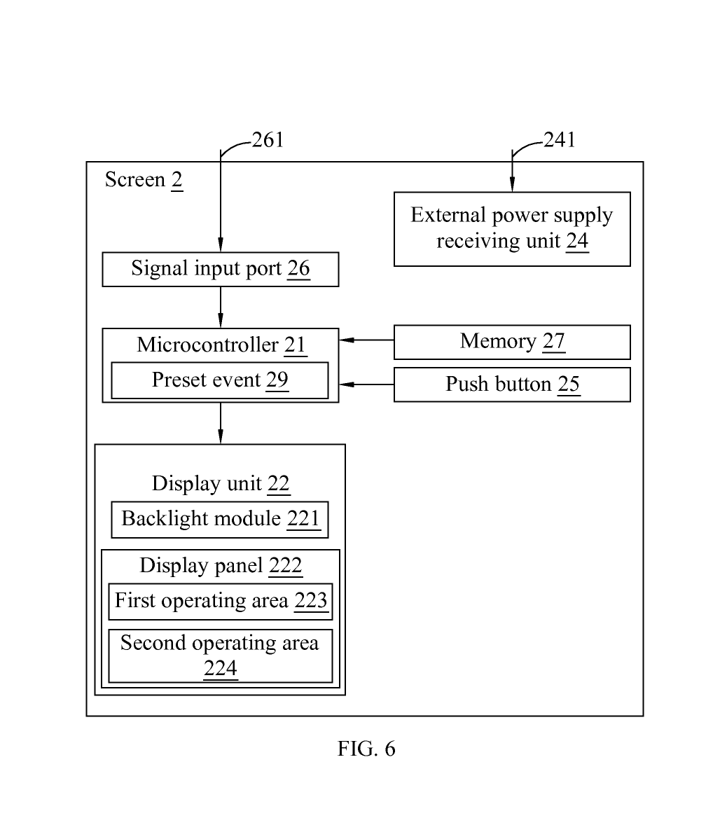

FIG. 6 is a block diagram of an electronic device according to a second embodiment of the present invention. In the second embodiment, the electronic device is a screen 2. As shown, the screen 2 includes a microcontroller 21, a display unit 22, an external power supply receiving unit 24, a push button 25, a signal input port 26, and a memory 27. The external power supply receiving unit 24 is connected to a power cord 241 for receiving an external power supply and providing power to elements in the screen 2. The display unit 22 includes a backlight module 221 and a display panel 222. The microcontroller 21 receives image data 261 via the signal input port 26 and performs image processing on the received image data 261. The processed image data 261 is then displayed on the display panel 222 of the display unit 22. On the display panel 222, there are a first operating area 223 and a second operating area 224. The backlight module 221 emits light, which passes through the display panel 222 for the user to clearly view the image shown on the display panel 222. The signal input port 26 is preferably a VGA (video graphics array) port, a HDMI (high-definition multimedia interface) port, or a DVI (digital visual interface) port.

When detecting the occurrence of a preset event 29, the microcontroller 21 adjusts the display unit 22 to display in a power-saving mode. The preset event 29 can include at least one of the following conditions:

(i) The microcontroller 21 receives an execution command signal via the signal input port 26. The execution command signal is generated for adjusting the screen 2 of an electronic device to display in the power-saving mode; and

(ii) The microcontroller 21 receives a trigger signal being generated when the push button 25 has been pushed. For example, the push button 25 can be defined as a power-saving button. By pushing the power-saving button, the user can actuate the power-saving display mode.

When entering the power-saving display mode, the microcontroller 21 will adjust the display parameters, for example, including the contrast, the brightness, the saturation, and/or the sharpness of the image shown in the first operating area 223 or the second operating area 224, so that the display definition of the first operating area is higher than that of the second operating area 224. Further, in the case the display unit 22 includes a plurality of light-emitting units, which may be controlled by the microcontroller 21, the microcontroller 21 can adjust the light-emitting units corresponding to the first operating area 223 to have brightness higher than other light-emitting units corresponding to the second operating area 224 does. Thus, the display definition of the first operating area is higher than that of the second operating area 224. Since the same operation has been described in the first embodiment, it is not repeatedly discussed herein.

Further, the first operating area 223 and the second operating area 224 can be defined through one of the following ways:

(i) The microcontroller 21 receives the initial position, the size, and the layer of the first operating area 223 via the signal input port 26; and the second operating area 224 is the area on the display panel 222 other than the first operating area 223. The first operating area 223 can be, for example, a window-based interface being generated when the electronic device executes a Windows Operating System. Preferably, the first operating area 223 is a currently in-focus window-based interface. Alternatively, the first operating area 223 can be a video playback area on the display panel 222, at where an electronic device plays back a multimedia file; and the second operating area 224 is the area on the display panel 222 other than the first operating area 223; and

(ii) The microcontroller 21 performs image processing on the received image data 261 in order to determine a window-based interface, an interface area of an application program, or a video playback area to be the first operating area 223; and to determine the second operating area 224 is the area other than the first operating area 223 on the display panel 222.

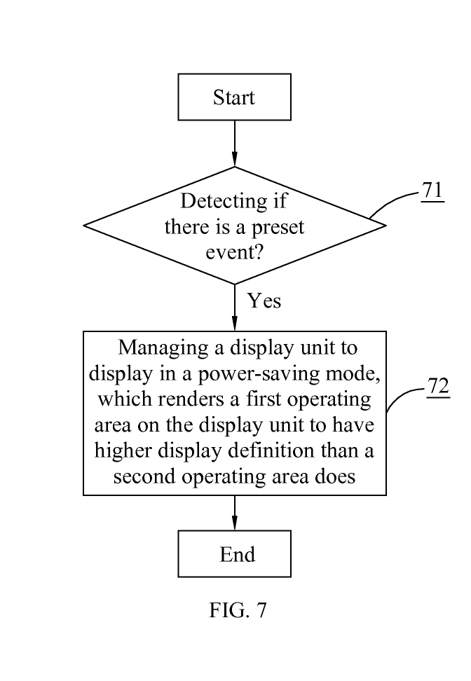

Please refer to FIG. 7 that is a flowchart according to the present invention and showing the steps of a power saving method implementing on an electronic device. The electronic device has a display unit comprising a first operating area and a second operating area both shown on a screen of the display unit. In a first step 71, after starting the power saving method, it detects whether a preset event has occurred or not. The preset event is defined as the actuation of a power-saving display mode for the electronic device, the removal of an external power supply from the electronic device, powering the electronic device with a battery, the battery level of the electronic device being lower than a preset value, or receiving an execution command signal by the electronic device.

Then, once the preset event is detected, the method will go to a second step 72, in which the display unit is controlled to display in a power-saving mode, and the first operating area is adjusted to have display definition higher than that of the second operating area. Then, the flow of the power saving method is stopped. In an operable embodiment of the present invention, the first operating area or the second operating area can be a window-based interface being generated when the electronic device executes a Windows Operating System. Preferably, the first operating area is a currently in-focus window-based interface. Alternatively, the first operating area can be an application program's interface area or a video playback area; and the second operating area is the area on the display unit other than the first operating area.

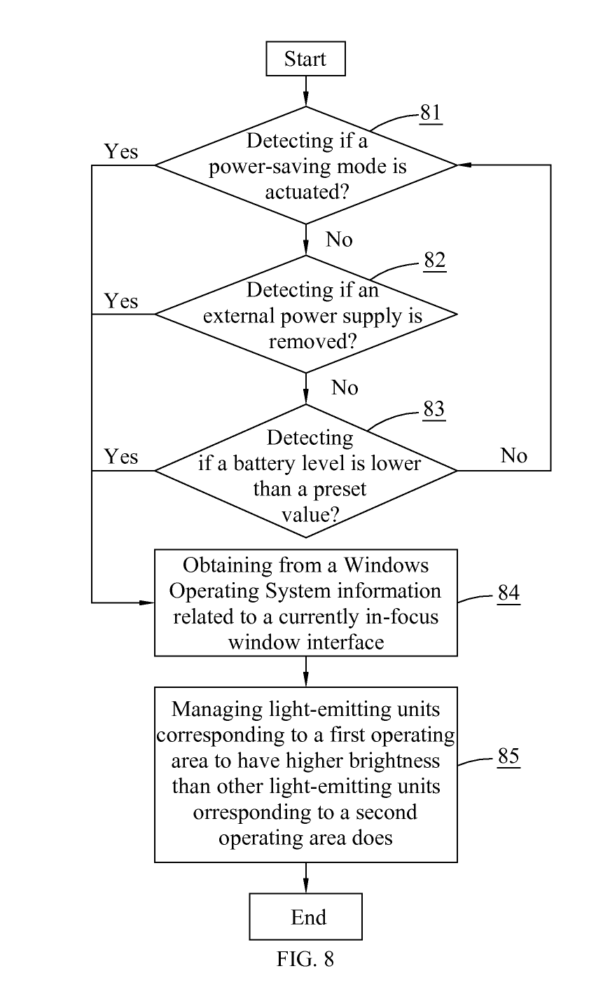

Please refer to FIG. 8 that is a flowchart according to the present invention and showing the steps included in an embodiment of the power saving method implementing on an electronic device. The electronic device executes a Windows Operating System and has a display unit that includes a plurality of light-emitting units, a first operating area, and a second operating area, which first and second operation area are shown on a screen of the display unit. As shown in FIG. 8, in the first step 81 after starting the power saving method, it detects whether a power-saving mode for the electronic device has been actuated or not; if yes, goes to a step 84; or if no, goes to a step 82. In the step 82, it detects whether an external power supply has been removed from the electronic device or not; if yes, goes to the step 84; or if no, goes to a step 83. In the step 83, it detects whether the battery level of the electronic device is lower than a preset value; if yes, goes to the step 84; or if no, goes back to the step 81. The steps 81, 82 and 83 are performed to detect and determine whether the display unit is to display in the power-saving mode. However, it is understood the power saving method of the present invention is not limited to only these three steps in determining whether to enter into the power-saving display mode. Any event related to the determination on entering into the power-saving display mode is included in the scope of the present invention.

In the step 84, information related to the currently in-focus window-based interface, such as the size, the location, and/or the layer thereof is obtained from the Windows Operating System, and the area in the currently in-focus window-based interface is defined as a first operating area while the area in a screen of the display unit of the electronic device. Also, the area other than the first operating area is defined as a second operating area.

Then, in the step 85, the display unit adjusts the light-emitting units corresponding to the first operating area to have brightness higher than other light-emitting units corresponding to the second operating area. In this manner, the window-based interface on which the user currently operates can still have sufficient brightness and display definition while the power consumed by the display unit is reduced. Moreover, depending on actual need, the method can further include the step of adjusting the display parameters for the image shown in the second operating area, so that the second operating area can have increased display definition without increasing the power consumption of the display unit.

The present invention has been described with some preferred embodiments thereof and it is understood these embodiments are illustrated only for exemplification and not intended to limit the present invention. The control of the light-emitting units to different brightness or the adjustment of the display parameters can be performed independently or at the same time. It is also understood that many changes and modifications in the described embodiments can be carried out without departing from the scope and the spirit of the invention that is intended to be limited only by the appended claims.

What is claimed is:

1. An electronic device, comprising:
a data processing unit capable of processing a data; and
a display unit capable of displaying the processed data, and the display unit comprising a screen displaying a first operating area and a second operating area shown thereon;
wherein the data processing unit controls the display unit into a power-saving mode by having higher display definition in the first operating area than display definition in the second operating area when a preset event is detected.

2. The electronic device as claimed in claim 1, wherein the preset event comprises any one of the following conditions: a power-saving mode is actuated on the electronic device; an external power supply of the electronic device is removed; the electronic device is powered by a battery; the battery level of the electronic device is lower than a preset value; and an execution command signal is received by the data processing unit.

3. The electronic device as claimed in claim 1, wherein the display unit comprises a plurality of light-emitting units; after detecting the preset event, a first group of the plurality of light-emitting units corresponding to the first operating area have higher brightness than a second group of light-emitting units corresponding to the second operating area.

4. The electronic device as claimed in claim 1, wherein the data processing unit executes a Windows Operating System, and one of the first operating area and the second operating area is a window-based interface generated by the Windows Operating System.

5. The electronic device as claimed in claim 4, wherein the first operating area is an in-focus window-based interface.

6. The electronic device as claimed in claim 1, wherein the data processing unit determines a video playback area shown on the screen of the display unit, and the first operating area is the video playback area and the second operating area is the screen except the first operating area.

7. The electronic device as claimed in claim 1, wherein the data processing unit performs image processing on the data to determine an interface area of an application program, and the first operating area is an interface area of the application program and the second operating area is the screen except the first operating area.

8. The electronic device as claimed in claim 1, wherein the data processing unit adjusts display parameters for an image shown in any of the first operating area and the second operating area, resulting higher display definition of the first operating area than that of the second operating area.

9. The electronic device as claimed in claim 8, wherein the display parameters comprise contrast, brightness, saturation, or sharpness of the image.

10. The electronic device as claimed in claim 1, wherein the electronic device is a screen, a computer, or a portable device.

11. A power saving method for implementing on an electronic device comprising a data processing unit and a display unit, the display unit comprising a screen displaying a first operating area and a second operating area thereof, the power saving method comprising the following steps:
detecting whether a preset event has occurred by the data processing unit disposed on an electronic device; and
controlling the display unit into a power-saving mode by the data processing unit when the preset event is detected, wherein the first operating area is rendered to have higher display definition than the second operating area does in the power-saving mode.

12. The power saving method as claimed in claim 11, wherein the preset event comprises any one of the following conditions: a power-saving mode is actuated on the electronic device; an external power supply of the electronic device is removed; the electronic device is powered by a battery; the battery level of the electronic device is lower than a preset value; and an execution command signal is received by the data processing unit.

13. The power saving method as claimed in claim 11, further comprising the following step when the display unit includes a plurality of light-emitting units:
managing the plurality of light-emitting units to form a first group of the light-emitting units corresponding to the first operating area having higher brightness than a second group of light-emitting units corresponding to the second operating area.

14. The power saving method as claimed in claim 11, wherein one of the first operating area and the second operating area is a window-based interface generated when the electronic device executes a Windows Operating System.

15. The power saving method as claimed in claim 14, wherein the first operating area is an in-focus window-based interface.

16. The power saving method as claimed in claim 11, further comprising a step of determining a video playback area shown on the screen of the display unit, the first operating area being the video playback area, and the second operating area being the screen except the first operating area.

17. The power saving method as claimed in claim 11, further comprising a step of performing image processing on an image shown on the screen of the display unit to determine an interface area of an application program, and the first operating area being the interface area of application program and the second operating area being the screen except the first operating area.

18. The power saving method as claimed in claim 11, further comprising a step of adjusting display parameters for an image shown in any of the first operating area and the second operating area, resulting higher display definition of the first operating area than that of the second operating area.

19. The power saving method as claimed in claim 18, wherein the display parameters comprise contrast, brightness, saturation, or sharpness of the image.
